(19) United States
(12) Patent Application Publication
(10) Pub. No.: US 2005/0168337 A1
(43) Pub. Date: Aug. 4, 2005

(54) Wirelessly loaded speaking medicine container

(76) Inventor: Jerome R. Mahoney, Colts Neck, NJ (US)

Correspondence Address: Kenneth P. Glynn, Esq.;Glynn & Associates, P.C., 24 Mine Street, Flemington, NJ, 08822, US

(21) Appl. No.: 10/768,930

(22) Filed: Jan. 30, 2004

(51) Int. Cl. G08B 1/08

(52) U.S. Cl. 340/539.12

(57) ABSTRACT

The present method of communicating prescription medicine instructions to patient, includes: (a.) providing a medicine container with a microprocessor, and, (b.) providing a central processor separate from the medicine container. The medicine container has the microprocessor attached to the medicine container. The microprocessor includes: (a)(i) a wave file receiving chip; (a)(ii) a wave file storage means; (a)(iii) a wave file audio playback means; (a)(iv) an audio playback start means; and (a)(v) a power supply within the microprocessor. The central processor includes: (b)(i) user input means; (b)(ii) text-to-speech means; (b)(iii) wave file means to create a wave file from the text-to-speech means; and (b)(iv) wireless transmission means to transmit the wave file to the microprocessor wave file receiving chip. Wireless transmission may be radio frequency (RF) transmission systems, infrared (IR) transmission systems and any other wireless transmission systems that are now available or may become available.

### BACKGROUND OF THE INVENTION

1. Field of the Invention

The present invention relates to speaking medicine containers, and, more particularly, first creating prescription medicine instructions in a central computer, wirelessly transmitting those instructions to a medicine container, and storing them for subsequent audio playback by a user. Thus, the present invention relates to both the method of performing these steps, and the combination of devices and software (the system) for doing this.

2. Information Disclosure Statement

The following prior art is representative of the state of the art in the field of pertinent medicine containers or the art pertaining to wireless communications:

U.S. Pat. No. 6,563,911 B2 describes the present invention a speech enabled automatic telephone dialer device, system, and method using a spoken name corresponding to name-telephone number data of computer-based address book programs. The invention includes user telephones connected to a PBX-type telephony mechanism, which is connected to a telephony board of a name dialer device. User computer workstations containing loaded address book programs with name-telephone number data are connected to the name dialer device. The name dialer device includes a host computer in a network; a telephony board for controlling the PBX for dialing; a memory within the host computer for storing software and name-telephone number data; and, software to access computer-based address book programs, to receive voice inputs from the PBX-type telephony mechanism, to create converted phonemes from names to match voice inputs with specific name-telephone number data from the computer-based address book programs for initiating an automatic dialing.

U.S. Pat. No. 6,463,462 B1 describes an automated system for delivery of messages to multiple recipients, and for processing of responses to the messages, includes a message client, message server, and system database. A message is created using universal message form. The message content can be translated in to multiple formats and sent to one or-more different recipients using one or more different types of messaging devices, including pagers, telephones, fax machines, and e-mail readers. A recipient profile manager allows each recipient to select the messaging devices to be used for message delivery as well as preferred messaging schedules, priorities, and messages security. Receipt of the messages by the recipients is verified, response requirements collected and consolidated from multiple sources and presented to the message originator in structured format.

U.S. Pat. No. 6,394,278 B1 describes a system and method for assisting an operator in sorting mail includes a wireless headset equipped with a microphone, and a workstation that includes a processing unit, voice-recognition and voice-synthesis circuitry, and a database. In operation, addressee information spoken into the microphone is transmitted to the work station where it is used to search the database. Destination information from a matching database record is then output to the operator on one or more of a display terminal, head set speakers, and heads-up display fixed to the head-set. The convenience and enhanced capability provided by this system steaminess operator productivity and sorting volume. The embodiments disclosed herein are primarily directed to a headset that is operated completely remotely from the processing unit, and also to a head set comprising a heads up display having means by which an operator can access the database.

U.S. Pat. No. 6,380,858 B1 describes systems and methods that are provided for facilitating effective self-management of medication treatment by patients. A Smart Tray monitors and reports to third parties a patient's compliance with various medication treatment regimens. Medication containers are provided with electromagnetic tags that provide various informations about medicament contained within a respective container. A Smart Tray is equipped with a processor and reader that interrogates each respective electromagnetic tag to identify medicament(s) contained within each container. Using the retrieved information, a Smart Tray provided visual and/or audio signals to a patient to remind the patient when and how much of various medicaments to take. A Smart Tray also monitors, via the reader, when a mediation container is removed. A Smart Tray can communicate with one or more third parties, such as healthcare products and services via a computer network. In addition, a Smart Tray can communicate with various appliances and can modify medication regimens for particular medicaments in response to data received from various appliances.

U.S. Pat. No. 6,294,999 B1 describes systems and methods that are provided for facilitating effective self-management of medication treatment by patients. A Smart Tray monitors and reports to third parties a patient's compliance with various medication treatment regimens. Medication containers are provided with electromagnetic tags that provide various informations about medicament contained within respective container. A Smart Tray is equipped with a processor and reader that interrogates each respective electromagnetic tag to identify medicament(s) contained within each container. Using the retrieved information, a Smart Tray provides visual and/or audio signals to a patient to remind the patient when and how many of various medicaments to take. A Smart Tray also monitors, via the reader, when a medication container is removed. A Smart Tray can communicate with one of more third parties, such as healthcare providers, pharmacies, and other suppliers of healthcare products and services via a computer network. In addition, a Smart Tray can communicate with various appliances and can modify medication regimens for particular medicaments in response-to data received from various appliances.

U.S. Pat. No. 6,150,942 describes an interactive prescription compliance, and life safety system that provides remote and on site verification of procedures related to the health status of a person, including taking of medicines, responsiveness to queries, and attendance of health care and service providers in the home by providing for signals to and from a person's location, with alarm activation when a deviation from a preprogrammed procedure occurs.

U.S. Pat. No. 6,032,155 describes an invention that related to a method and apparatus for administering prescribed medication to a patient. The prescribed medication administration 15 system and apparatus dispense prescribed medication, verify the medication is given to a correct patient by and authorized healthcare worker and tracks and records the administration of the medication. The system utilizes a workstation connected to a database containing prescribed medication dose information for various patients. A healthcare worker uses the workstation to manually or automatically dispenses the medication the portable container. An information device is secured to the portable container during transport and administration of the medication to the intended patient. The information device prevents access to the medication or warns the healthcare worker of a potential error if the medication is delivered to the wrong patient or administered by an unauthorized healthcare worker. The information device records actual consumption information, and delivers this information back the workstation database or to a hospital or pharmacy database.

U.S. Pat. No. 6,021,433 describes a system and method for data communication connection on-line networks with on-line computers. The present system provides for broadcast of up to the minute notification centric data there by providing an instant call to action for users who are provided with the ability to instantaneously retrieve further detailed information. Information sources transmit data to a central broadcast server, which preprocesses the data for wireless broadcast. The notification centric portions of data are wirelessly broadcast to wireless receiving devices that are attached to computing devices. Upon receipt of the dada the computing device, the user is notified through different multimedia alerts that there is an incoming message. Wirelessly broadcasted URL's, associated with the data, are embedded in data packets and provide an automated wired or wireless connection back to the information source for obtaining detailed data.

U.S. Pat. No. 6,018,289 describes a prescription compliance device which aids patients in complying with instructions given by a physician for taking prescription medication. The device reminds a patient when the next dose of medication is to be taken and indicates whether a specified dose has been taken. The device includes a microcontroller, a display, a program memory for storing pre-programmed medication-taking regimens and for programming the device as to the time and day on which the first dose of medication is to be taken, a display which alternately displays the current time and a time at which a next dose of medication is to be taken, and an alarm which alerts the patient at times when a dose of medication is to be taken. The selector includes an event switch, which is activated by the patient after taking a dose of medication so as to record the taking of the medication and to cause the microcontroller to effect the display of the next time at which a dose of medication is to be taken. A memory may also be included to record the times at which a patient takes doses of medication. The device is small enough to be attached to medication containers, and includes a remote programming feature via a wireless link.

U.S. Pat. No. 5,917,429 describes a means which digital data are communicated between a portable data-gathering unit and a date-receiving unit without direct electrical connection by transmitting the data over a contactless connection system. In a preferred embodiment, data flow is bidirectional.

U.S. Pat. No. 5,846,089 describes a medicine container that provides audible dosage instructions in a voice recognizable to the user, so that the user, even with a sight or like disability, can rely on voice recognition as providing verification of the accuracy and particular appropriateness of the dosage instructions to the user of the medicine container.

U.S. Pat. No. 5,835,455 describes a reprogrammable device for removably receiving a medicine container and for providing audio instructions to a patient for taking a medication. When a medicine container is removed from the device by the patient so that the patient may take the medicine, the device can be activated to play a pre-recorded individualized message from the pharmacist providing the patient audio instructions for taking the medication.

U.S. Pat. No. 5,774,865 describes the patient compliance and monitoring device that utilizes a tray with a base for holding medicine containers such as bottles. Inside the base attached to the tray in a weight scale connected to a computer. Also connected to the computer are an alphanumeric keyboard and an LCD monitor which attached to the base. The computer entails a microprocessor connected to ROM and RAM and encoded with instruction sets to determine the dosage taken by a user as well as the date and time taken. The medicine containers are detected, preferably, by a bar code reader inside the base scanning bar code labels attached to the bottom of the medicine containers.

U.S. Pat. No. 5,014,798 describes a present invention that is directed to a cap for a medicine bottle for monitoring a patient's medicine compliance. In involves weighing a container of medicine with cap with includes scale means located therein which is connected to a computer chip with a display unit also located in or on the cap. The chip may store the starting weight or tare weight, plus total weight and when the container or medicine is picked up by the cap at any time, actual weight is fed to the chip. The computer chip may they determine the difference between the starting weight and/or display actual amount of medicine remaining or consumed. The container of medicine is reweighed from time to time with the cap and then chip may compare actual weight with compliance required weight to determine compliance and the cap may visually display the compliance results on the display unit to inform the patient. An optional audio assist may direct the patient to “call the doctor” if a significant compliance deviation is recognized.

Notwithstanding the prior art, the present invention is neither taught nor rendered obvious thereby.

### SUMMARY OF THE INVENTION

The present invention relates to a method of communicating prescription medicine instructions to patient, this method includes: (a.) providing a medicine container with a microprocessor, and, (b.) providing a central processor separate from the medicine container. The medicine container includes a storage area for medicine and some type of closure, e.g., a cap, and has the microprocessor attached to the medicine container. The microprocessor includes: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor.

The central processor includes: (b)(i) user input means; (b)(ii) text-to-speech means; (b)(iii) wave file means to create a wave file from the text-to-speech means; and (b)(iv) wireless transmission means to wirelessly transmit the wave file from the central processor to the microprocessor wave file receiving chip. The phrase “wireless transmission means” shall include radio frequency (RF) transmission systems, infrared (IR) transmission systems and any other wireless transmission systems that are now available or may become available for a transmission of data over airwaves.

The method further includes: (c.) inputting the user input means to create prescription medicine instruction text; (d.) converting the text to electronic speech; (e.) creating a wave file with the electronic speech; (f.) transmitting the wave file to the microprocessor wave file receiving chip; and (g.) storing the wave file for subsequent playback by a user by activating the audio playback starting means.

In some preferred embodiments, the present invention method central processor is a computer system and the user input means is a conventional computer user input means selected from keyboard, mouse, ball and touch pad.

In other preferred embodiments of the present invention method, the following steps are: (h.) creating a unique identifier in the central processor; (i.) transmitting the unique identifier to the microprocessor; and (j.) providing accessing means for accessing the unique identifier from the microprocessor.

The microprocessor may be attached to a bottom of the medicine container, to a top of the medicine container, to a wall of the medicine lo container or to a cap or other closure.

In some embodiments, the user input means is a microphone and the central processor includes conversion means for converting speech to electronic input.

An alternative embodiment present invention method of communicating prescription medicine instructions to a patient includes: (a.) providing a medicine container, the medicine container including a storage area for medicine, and a microprocessor attached to the medicine container. The microprocessor includes: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor; and (b.) providing a central processor separate from the medicine container. The central processor includes: (b)(i) user input means for inputting electronic prescription medicine instruction input; (b)(ii) wave file means to create a wave file from Said electronic prescription medicine instruction input from the input means; and (b)(iii) wireless transmission means to wirelessly transmit the wave file from the central processor to the microprocessor wave file receiving chip. This alternative method also includes the steps of: (c.) inputting prescription medicine instructions with the user input means to create electronic input; (d.) creating a wave file with the electronic input; (e.) transmitting the wave file to the microprocessor wave file receiving chip; (f.) storing the transmitted wave file for subsequent audio playback by a user by activating the audio playback starting means.

The present invention also relates to a system (combination of equipment and software) for communicating prescription medicine instructions to a patient by wireless communication from a central processor to a medicine container for subsequent audio speech playback from the medicine container to a user. The system includes: (a.) a medicine container, the medicine container including a storage area for medicine, and a microprocessor attached to the medicine container, the microprocessor including: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor; and (b.) a central processor separate from the medicine container, the central processor including: (b)(I) user input means; (b)(ii) text-to-speech means; (b)(iii) wave file means to create a wave file from the text-to-speech means; and (b)(iv) wireless transmission means to wirelessly transmit the wave file from the central processor to the microprocessor wave file receiving chip.

An alternative embodiment present invention system for communicating prescription medicine instructions to a patient by wireless communication from a central processor to a medicine container for subsequence audio speech playback from the medicine container to a user, includes: (a.) a medicine container including a storage area for medicine, and a microprocessor attached to the medicine container, the processor including: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor it also includes; (b.) a central processor separate from the medicine. The central processor including: (b)(i) user input means said electronic prescription medicine instrument input. (b)(ii) wave file means to create a wave file from the text-to-speech means; and (b)(iii) wireless transmission means to transmit the wave file from the central processor to the microprocessor wave file receiving chip.

These systems may be computer systems, and the user input means may be a conventional computer user input means selected from keyboard, mouse, ball and touch pad.

The systems may optionally include: (h.) means for creating a central processor unique identifier in the central processor; (i.) means for transmitting said unique identifier to the microprocessor; and (j.) providing accessing means for accessing the central processor unique identifier from the microprocessor.

The systems may be system wherein the user input means is a microphone and the central processor included reversion means for converting speech to electronic input.

### BRIEF DESCRIPTION OF THE DRAWINGS

The present invention should be more fully understood when the specification herein is taken in conjunction with the drawings appended hereto wherein:

FIG. 1 illustrates a schematic diagram of one preferred embodiment of the present invention method and system;

FIG. 2 shows another schematic diagram of an alternative embodiment of a present invention method and system;

FIG. 3 shows a diagrammatic representation of a present invention system; and

FIG. 4 illustrates another preferred embodiment of the present invention method and system for wirelessly transferring prescription medicine instructions from a central processor to a medicine container for subsequent audio playback by a user.

### DETAILED DESCRIPTION OF THE PRESENT INVENTION

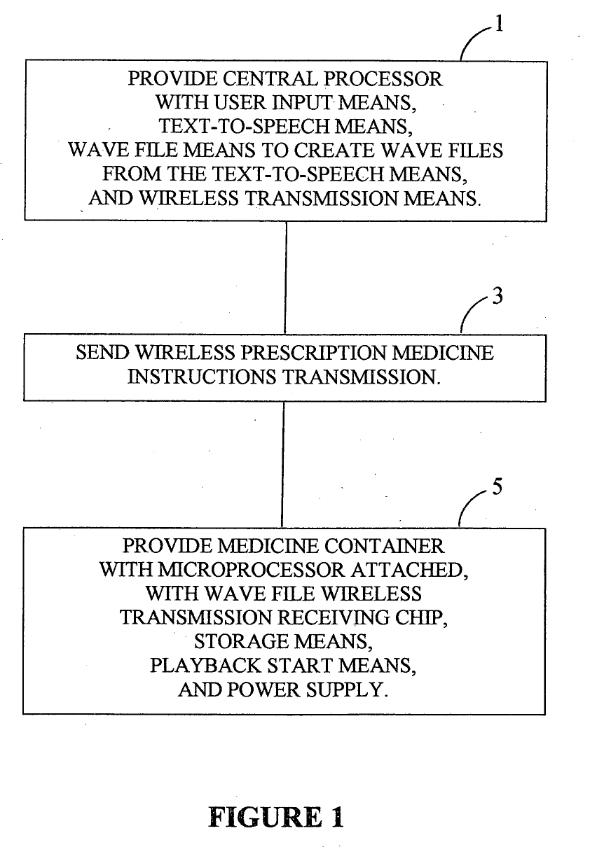

FIG. 1 illustrates a schematic diagram of one preferred embodiment of the present invention method and system. In FIG. 1, central processor 1 may be any type of central processor that is available and is capable of supporting the necessary hard were and soft were to perform the functions described herein. Thus, the central processor 1 could be a collection of intranet connected units, a server, a stand alone computer, a PC, a notebook, a lap top or even a multimedia system or handheld computer, or a device that includes a computer.

Central processor 1 requires user input means and this could be any available user means, but is typically a ball, a mouse, a key pad, a microphone, or combinations of these. It also includes text-to-speech means and these are well known systems that convert electronic text to speech. These are well known programs and wold be familiar to one of ordinary skill in this art. For example, U.S. Pat. No. 6,394,278 B1 and patents cited therein show speech-to-text and text-to-speech capabilities.

Central processor 1 also includes wave file means to create wave files from the text-to-speech means, as well as wireless transmission means. Wave files creation and wireless transmission, not in the present invention system, are known to the artisan and are described in the cited prior above.

The user will use the input means to create the wave files by normal input of prescription medicine instructions, and these are wirelessly transmitted 3 to medicine container 5.

Medicine container 5 includes a microprocessor attached to it that receives the wave file wireless transmission, storage means for storing the wave file and whatever additional software that may be required to create audible speech patterns. Medicine container 5 also includes play back and play back start means as well as a power supply. Typically, the microprocessor would be located on the bottom of the medicine container and would be cylindrical or otherwise conformed to the general shape of the medicine container. Alternatively, it could have any convenient shape and be located on any aria of the medicine container or its cap. It would include a start mechanism that could be a button or switch, or its equivalent. A user would simply activate the start mechanism and the microprocessor would automatically play back the prescription instructions.

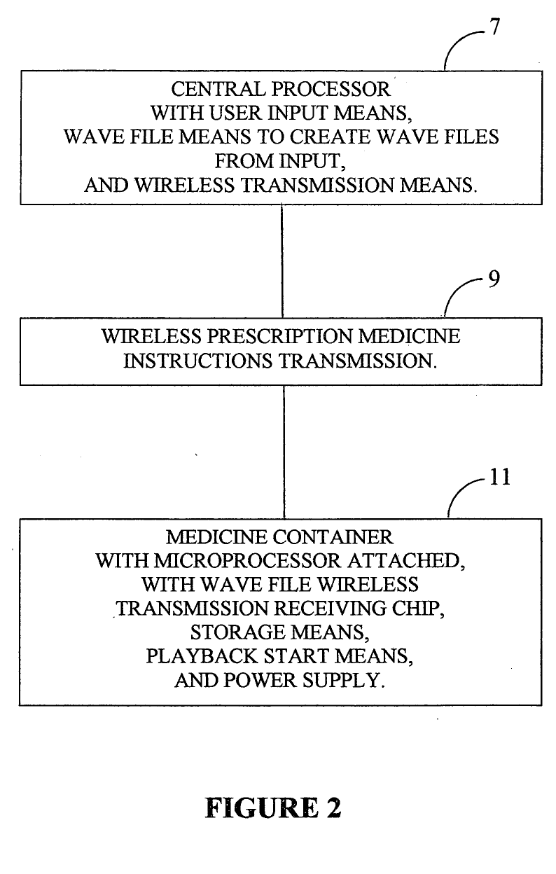

FIG. 2 shows another schematic diagram of an alternative embodiment of a present invention method and system. In this embodiment, the central processor 7 functions similarity to central processor 1 above but creates wave files directly from inputs and transmits 9 these to container 11. Medicine container 11 functions similarity to medicine container 5 of FIG. 1.

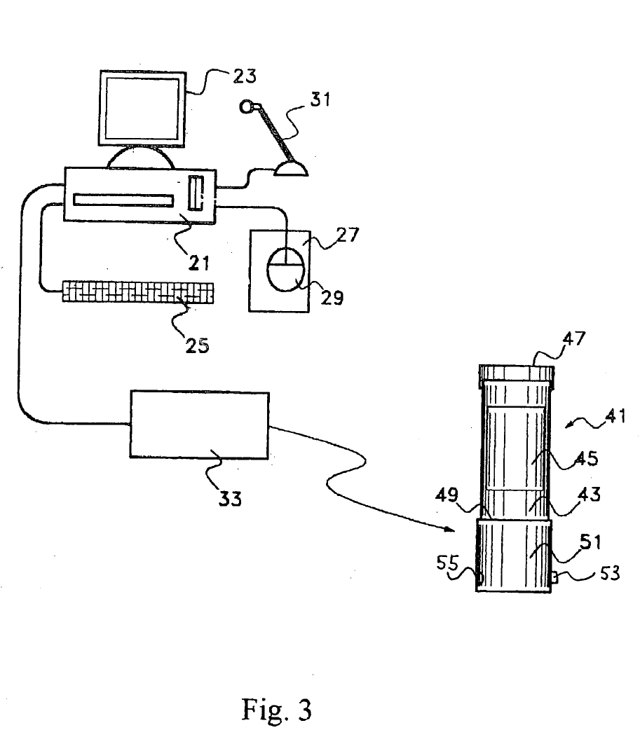

FIG. 3 shows a diagrammatic representation of a present invention system. There is a central processor, in this case, computer 21 with monitor 23, as well as impute means which, in this embodiment, are shown to be keyboard 25, mouse 27 and pad 29 and microphone 31. A slider, joystick, or touch ball, or any other input means could be lo included in addition to or in place of those shown in the figure.

Computer 21 could be a master server, a personal computer, or any other type of computer. Computer 21 is connected to transmitter 33 for short distance transmission of the wave file. While this is shown as a separate device wired to computer 21, it could be built in to a computer unit with appropriate hardware, software and middleware. This wirelessly transmits the wave file package with optional unique identifier information to medicine container 41, and, more particularly to its microprocessor 51 attached to container bottom 49. Container 41 includes atypical medicine storage 43, a label 45 and a cap 47. Playback start button 53 enables a user to playback the received and stored wave file packet prescription medicine instruction as often as desired.

Microprocessor 51 includes a wave file wireless transmission receiving chip and a power supply, as well as storage means and optional unique identifier retrieval means. This could be a plug in port such as port 55

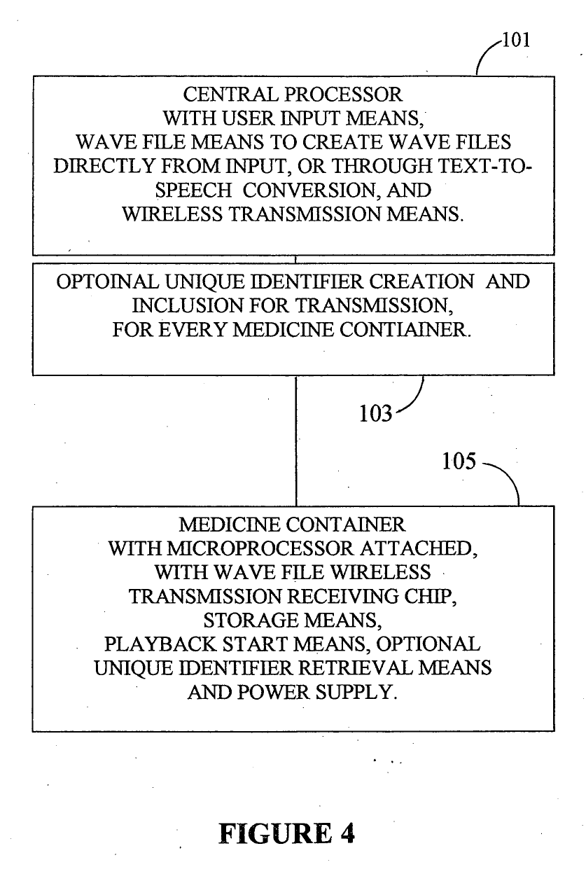

FIG. 4 illustrates another preferred embodiment of the present invention system for wirelessly transferring prescription medicine instructions from a central processor to a medicine container for subsequent audio playback by a user. Central processor 101 may be arranged as in FIG. 1 or as in FIG. 2 above, and, includes optional unique identifier capabilities 103. This includes sufficient equipment and software to create a unique identification code for each and every medicine container to which a wave file is sent. This code could be any combination of numbers and/or letters and/or symbols.

In one preferred embodiment of the present invention, the system is provided to a pharmacist or similar functionary, who inputs the appropriate prescription medicine instruction for creation wave file, and transmission to the receiving medicine container microprocessor. A number of variations are possible. For example, the wave file may include a unique identifier along with other information, such as the patients name, the doctor name, date and/or pharmacy name.

In one preferred embodiment, the software is set up to present queries or blanks for the pharmacist, asking for patient and product information, date, ect. and will provide a location for specific instructions. This software program will create records for the pharmacist, print out a label for the medicine container and create a wave file, with requiring only a single set of inputs. The unique identifier may include date and pharmacy location information, patient information and unique characters for each particular medicine container.

In another embodiment, the software program of the central processor may contain list of various pharmaceutical products with different dosages so that a pharmacist may click a specific product and dosage, and a specific set of prescription instructions will appear. The pharmacist will click to confirm and this will be inserted in to a file for addition patient and other input. A preexisting wave file corresponding to that selection by the pharmacist will be automatically brought up and wirelessly transmitted to the medicine container microprocessor when the pharmacist clicks a send directive.

In yet other embodiments of the present invention, the pharmacist central processor could be connected to the internet so as to connect with a particular internet site that would provide dosage information and even wave file packets from individual pharma companies, or a separate clearing house service that would include information from many or all major pharma companies.

Obviously, numerous modifications and variations of the present invention are possible in light of the above teachings. It is therefore understood that within the scope of the appended claims, the invention may be practiced otherwise than as specifically described herein.

1. A method of communicating prescription medicine instructions to patient, which comprises:
(a.) providing a medicine container, said medicine container including a storage area for medicine, and a microprocessor attached to a said medicine container, said microprocessor including:
(a)(i) a wave file receiving chip;
(a)(ii) a wave file storage means;
(a)(iii) a wave file audio playback means;
(a)(iv) an audio playback start means; and
(a)(v) a power supply within said microprocessor adapted to power components of said microprocessor;
(b.) providing a central processor separate from said medicine container, said central processor including:
(b)(i) user input means;
(b)(ii) text-to-speech means;
(b)(iii) wave file means to create a wave file from said text-to-speech means; and
(b)(iv) wireless transmission means to wirelessly transmit said wave file from said central processor to said microprocessor wave file receiving chip;
(c.) inputting said user input means to create prescription medicine instruction text;
(d.) converting said text to electronic speech;
(e.) creating a wave file with said electronic speech;
(f.) transmitting said wave file to said microprocessor wave file receiving chip;
(g.) storing said wave file in said microprocessor for subsequent playback by a user by activating said audio playback starting means.

2. The method of claim 1 wherein said central processor is a computer system and said user input means is a conventional computer user input means selected from keyboard, mouse, ball and touch pad.

3. The method of claim 1 further comprising:
(h.) creating a unique identifier in said central processor;
(i.) wirelessly transmitting said unique identifier to said microprocessor; and
(j) providing accessing means for accessing said unique identifier from said microprocessor.

4. The method of claim 1 wherein said microprocessor is attached to at least one of a bottom, a top, a side of said medicine container and a cap connected to said container.

5. The method of claim 1 wherein said user-input means is a microphone and said central processor includes conversion means for converting speech to electronic input.

6. The method of claim 1 wherein said central processor further includes: (a)(vi) a preset data collection of prescription medicine instructions, including for different medications and different dosages, and sufficient software to permit a user to select appropriate prescription medicine instructions corresponding to a specific medication and dosage combination.

7. A method of communicating prescription medicine instructions to a patient, which comprises:
(a.) providing a medicine container, said medicine container including a storage area for medicine, and a microprocessor attached to said medicine container, said processor including:
(a)(i) a wave file receiving chip;
(a)(ii) a wave file storage means;
(a)(iii) a wave file audio playback means;
(a)(iv) an audio playback start means; and
(a)(v) a power supply within said microprocessor adapted to power components of said microprocessor
(b.) providing a central processor separate from said medicine container, and said central processor including:
(b)(i) user input means for inputting electronic prescription medicine instruction input;
(b)(ii) wave file means to create a wave file from said electronic prescription medicine input from said input means; and
(b)(iii) wireless transmission means to wirelessly transmit said wave file from said central processor to said microprocessor wave file receiving chip;
(c.) inputting prescription medicine instructions with said user input means to create electronic input;
(d.) creating a wave file with said electronic input;
(e.) transmitting said wave file to said microprocessor wave file receiving chip;
(f.) storing said transmitted wave file wireless transmission for subsequent audio playback by a user by activating said audio playback starting means.

8. The method of claim 7 wherein said central processor is a computer system and said user input means is a conventional computer user input means selected from the group consisting of keyboard, mouse, ball and touch pad.

9. The method of claim 7 further compromising:
(g.) creating a unique identifier in said central processor;
(h.) wirelessly transmitting said unique identifier to said microprocessor; and
(i.) providing processing means for accessing said unique identifier from said microprocessor.

10. The method of claim 7 wherein said microprocessor is attached to at least one of a bottom, a top, a side of said medicine container and a cap connected to said container.

11. The method of claim 7 wherein said user input means is a microphone and said central processor includes conversion means for converting speech to electronic input.

12. The method of claim 7 wherein said central processor further includes: (a)(vi) a preset data collection of prescription medicine instructions, including for different medications and different dosages, and sufficient software to permit a user to select appropriate prescription medicine instructions corresponding toga specific medication and dosage combination.

13. A system for communicating prescription medicine instructions to a patient by wireless communication from a central processor to a medicine container for subsequent audio speech playback from said medicine container to a user, which comprises:
(a.) a medicine container, said medicine container including a storage area for medicine, and a microprocessor attached to a said medicine container, said microprocessor including:
(a)(i) a wave file receiving chip;
(a)(ii) a wave file storage means;
(a)(iii) a wave file audio playback means;
(a)(iv) an audio playback start means; and
(a)(v) a power supply within said microprocessor, and adapted to power components of said microprocessor;
(b.) a central processor separate from said medicine container, said central processor including:
(b)(i) user input means;
(b)(ii) text-to-speech means;
(b)(iii) wave file means to create a wave file from said text-to-speech means; and
(b)(iv) wireless transmission means to wirelessly transmit said wave file from said central processor to said microprocessor wave file receiving chip.

14. The system of claim 13 wherein said central processor is a computer system and said user input means is a conventional computer user input means selected from keyboard, mouse, ball and touch pad.

15. The system of claim 13 further comprising:
(h.) creating a unique identifier in said central processor;
(i.) wirelessly transmitting said unique identifier to said microprocessor; and
(j.) providing accessing means for accessing said unique identifier from said microprocessor.

16. The system of claim 13 wherein said microprocessor is attached to at least one of a bottom, a top, a side of said medicine container and a cap connected to said container.

17. The system of claim 13 wherein said user input means is a microphone and said central processor included conversion means for converting speech to electronic input.

18. A system for communicating prescription medicine instructions to a patient by wireless communication from a central processor to a medicine container for subsequence audio speech playback from said medicine container to a user, which comprises:
(a.) a medicine container including a storage area for medicine, and a microprocessor attached to said medicine container, said processor including:
(a)(i) a wave file receiving chip;
(a)(ii) a wave file storage means;
(a)(iii) a wave file audio playback means;
(a)(iv) an audio playback start means; and
(a)(v) a power supply within said microprocessor, and adapted to power components of said microprocessor;
(b.) a central processor separate from said medicine container, and said central processor including:
(b)(i) user input means for inputting electronic prescription medicine instruction input;
(b)(ii) wave file means to create a wave file from said electronic prescription medicine input from said input means; and
(b)(iii) wireless transmission means to wirelessly transmit said wave file from said central processor to said microprocessor wave file receiving chip.

19. The system of claim 18 wherein said central processor is a computer system and said user input means is a conventional computer user input means selected from keyboard, mouse, ball and touch pad.

20. The system of claim 18 wherein comprising:
(h.) creating a unique identifier in said central processor;
(i.) wirelessly transmitting said unique identifier to said microprocessor; and
(j.) providing accessing means for accessing said unique identifier from said microprocessor.

21. The system of claim 18 wherein said microprocessor is attached to at least one of a bottom, a top, a side of said medicine container and a cap lo connected to said container.

22. The system of claim 18 wherein said user input means is a microphone and said central processor includes conversion means for converting speech to electronic input
